(19) United States
(12) Patent Application Publication
(10) Pub. No.: US 2026/0046655 A1
(43) Pub. Date: Feb. 12, 2026

(54) MEASUREMENT CONFIGURATION AND LOGGING AND REPORTING

(71) Applicant: Lenovo (Singapore) Pte Limited, Singapore (SG)

(72) Inventors: Tapisha SONI, Munich (DE); Joachim Löhr, Wiesbaden (DE); Hyung-Nam Choi, Ottobrunn (DE); Vahid Pourahmadi, Munchen (DE)

(21) Appl. No.: 18/798,679

(22) Filed: Aug. 8, 2024

(51) Int. Cl. H04W 24/10; H04W 36/00

(52) U.S. Cl. CPC H04W 24/10; H04W 36/0058; H04W 36/0088

(57) ABSTRACT

Various aspects of the present disclosure relate to a UE for wireless communication with at least one memory and at least one processor coupled with the at least one memory and configured to cause the UE to receive a first message comprising a data collection configuration from a network entity, the data collection configuration comprising at least one measurement configuration, at least one logging configuration, and at least one reporting configuration, perform measurements according to a measurement configuration of the at least one measurement configuration, log measurement data associated with the measurements according to a logging configuration of the at least one logging configuration by storing the measurement data in the at least one memory, and transmit a second message to the network entity based on a reporting configuration of the at least one reporting configuration, the second message comprising the logged measurement data.

### TECHNICAL FIELD

The present disclosure relates to wireless communications, and more specifically to measuring, logging and reporting of data.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include a UE for wireless communication with at least one memory and at least one processor coupled with the at least one memory and configured to cause the UE to receive a first message comprising a data collection configuration from a network entity, the data collection configuration comprising at least one measurement configuration, at least one logging configuration, and at least one reporting configuration, perform measurements according to a measurement configuration of the at least one measurement configuration, log measurement data associated with the measurements according to a logging configuration of the at least one logging configuration by storing the measurement data in the at least one memory, and transmit a second message to the network entity based on a reporting configuration of the at least one reporting configuration, the second message comprising the logged measurement data.

In some implementations of the method and apparatuses described herein, the first message comprises an indication to activate, deactivate, suspend or release one or more of a measurement configuration, a logging configuration, and a reporting configuration of the data collection configuration.

In some implementations of the method and apparatuses described herein, one or more of the at least one measurement configuration, the at least one logging configuration, and the at least one reporting configuration is linked to UE-side or network-side conditions.

In some implementations of the method and apparatuses described herein, the at least one processor is further configured to cause the UE to autonomously activate, deactivate, suspend or release the data collection configuration.

In some implementations of the method and apparatuses described herein, the at least one processor is further configured to cause the UE to transmit the second message based on at least one of an indication received from the network entity, satisfying a condition preconfigured at the UE, UE-side conditions, and network-side conditions.

In some implementations of the method and apparatuses described herein, the data collection configuration comprises an indication for a release timer, and the UE releases the data collection configuration when the release timer expires.

In some implementations of the method and apparatuses described herein, the at least one processor is further configured to cause the UE to release the data collection configuration in response to at least one of the following conditions: expiration of a release timer, a new data collection configuration with an identifier that matches an identifier of the data collection configuration, an indication received from the network entity, and expiration of a logging duration indicated by the data collection configuration.

In some implementations of the method and apparatuses described herein, the at least one processor is further configured to cause the UE to release the logged measurement data from the at least one memory based on one or more of: expiration of a discard timer, after reporting the logged measurement data, an indication received from the network entity, and satisfying a trigger condition at the UE.

In some implementations of the method and apparatuses described herein, the at least one processor is further configured to cause the UE to perform the measurements and store the measurements in the at least one memory while in an RRC_CONNECTED state.

In some implementations of the method and apparatuses described herein, the at least one processor is further configured to cause the UE to receive, in a handover process, a validity indicator from a target base station; compare the validity indicator to a validity area associated with the data collection configuration; and determine whether to continue performing the measurements and logging the measurement data based on a result of the comparison, wherein the UE is configured to continue performing the measurements and logging the measurement data when the validity indicator matches the validity area.

In some implementations of the method and apparatuses described herein, the at least one processor is further configured to cause the UE to perform at least one of releasing the data collection configuration and switching to a different data collection configuration when the validity indicator does not match the validity area.

### BRIEF DESCRIPTION OF THE DRAWINGS

FIG. 1 illustrates an example of a wireless communications system in accordance with aspects of the present disclosure.

FIGS. 2A, 2B, 2C and 2D illustrate examples of data collection configurations in accordance with aspects of the present disclosure.

FIGS. 3 and 4 illustrate examples information elements in accordance with aspects of the present disclosure.

FIG. 5 illustrates an example of a handover process in accordance with aspects of the present disclosure.

FIG. 6 illustrates an example of signaling for reporting during RRC connection establishment in accordance with aspects of the present disclosure.

FIG. 7 illustrates an example of a UEInformationRequest message information element in accordance with aspects of the present disclosure.

FIG. 8 illustrates an example of a UEInformationResponse message information element in accordance with aspects of the present disclosure.

FIG. 9 illustrates an example of a new process for establishment of an RRC connection for reporting logged data in accordance with aspects of the present disclosure.

FIG. 10 illustrates an example of a user equipment (UE) 1000 in accordance with aspects of the present disclosure.

FIG. 11 illustrates an example of a processor 1100 in accordance with aspects of the present disclosure.

FIG. 12 illustrates an example of a network equipment (NE) 1200 in accordance with aspects of the present disclosure.

FIGS. 13 and 14 illustrate flowcharts of methods performed by a UE in accordance with aspects of the present disclosure.

FIG. 15 illustrates a flowchart of method performed by a NE in accordance with aspects of the present disclosure.

### DETAILED DESCRIPTION

Wireless communication systems may support minimization of drive tests (MDT) for data collection (e.g., from an environment). MDT may enhance performance of the wireless communication systems, including network entities deployed in these wireless communication systems, by improving (e.g., optimizing) measurement and data collection. In some cases, these wireless communication systems may support MDT to decrease (e.g., minimize) a dependence on drive tests, which in some cases are used to collect data for network optimization and troubleshooting. A drive test involves physically routing testing equipment around coverage areas of wireless communication systems to collect data on network performance of the wireless communication systems (i.e., networks). Put another way, the drive test involves deploying personnel to physically drive around in vehicles equipped with measurement equipment to collect network performance data. As such, drive tests can be costly and time-consuming.

In accordance with MDT, a user equipment (UE) can be configured to measure network performance metrics, such as signal strength, signal quality, signal latency, signal coverage, etc. and report network performance data (also referred to as measurement data). This data can be used by network operators to evaluate and improve network performance. In some cases, the UE may collect data in real-time and/or over extended periods. In some cases, measuring, logging, and/or reporting of network performance data may be triggered by an event (e.g., in response to a request from a network entity) or performed periodically (e.g., based at least in part on a configuration). The different timing of measuring, logging, and/or reporting of network performance data enables network operators to obtain a comprehensive report (e.g., model, statistics) of network conditions without deploying extensive field-testing resources.

By way of example, a UE may be configured to measure and collect network performance data, which can include reference signal received power (RSRP), reference signal received quality (RSRQ), among other metrics. In some cases, the UE may report the network performance data in response to a predefined condition (e.g., in response to a request from a network entity, in response to network performance data satisfying a network performance data threshold (e.g., an RSRP satisfying an RSRP threshold, an RSRQ satisfying an RSRP threshold)). In some other cases, the UE may log (e.g., store) the network performance data for transmission to the network entity, for example, at a later time. This measurement, collection, and reporting of network performance data can provide continuous monitoring of network performance, allowing network operators to identify and resolve network issues, optimize network resource allocation, and enhance overall network service quality. As such, MDT leverages UEs to provide a cost-effective and efficient way to maintain and improve network performance.

Some cases for MDT, such as legacy MDT are configured separately for an RRC connected state of a UE and an RRC idle state of the UE. For the RRC connected state, the UE may measure, collect, and report network performance data without logging the data (i.e. storing the data for later transmission). Conversely, for the RRC idle state, the UE may log the network performance data. However, this logging is restricted to a single measurement configuration at a time. That is, under legacy MDT, the UE can only store network performance data and implement a single measurement configuration for the RRC idle state. In legacy MDT, a measurement configuration when the UE is in the RRC connected state is automatically overwritten upon receiving a new configuration for a same measurement identifier and released in response to receiving an explicit indication (e.g., measIdToRemoveList).

A wireless communication system, including NE and/or UE may support machine learning (ML) and artificial intelligence (AI). These technologies can be used by the NE and/or UE to improve network performance by processing data collected by the wireless communication system to adjust (e.g., modify, update, optimize) one or more network parameters. For example, AI/ML models can be used by the NE and/or UE for channel state information (CSI) feedback compression, modulation/demodulation, scheduling, interference management, positioning, among others. The configuration of AI/ML models may be use-case dependent. However, training (or updating, fine-tuning, and monitoring) of these AI/ML models may depend on data collected from an environment (e.g., via radio frequency (RF) measurements). In some cases, the quality of AI/ML models may be proportional to the amount of data used to train these models. Put another way, larger data sets produce better trained AI/ML models.

In legacy MDT, a network entity may initiate a measurement procedure for a UE in an RRC connected state, for example, by transmitting a message that indicates a measurement configuration (e.g., LoggedMeasurementConfiguration) to the UE. The measurement configuration may include one or more parameters for the legacy MDT. Because the provisioning of the measurement configuration is unidirectional, the UE can only release the measurement configuration by replacing it with a new measurement configuration, when a timer expires or a condition is satisfied. The UE can only maintain a single RAT-specific logged measurement configuration at a time. When the network entity provides a measurement configuration, any previous measurement configuration at the UE is entirely replaced by the provided measurement configuration. Additionally, logged measurements corresponding to the previous measurement configuration are cleared (e.g., discarded, dropped, erased). In some cases, the logged measurements may be cleared after a threshold duration (e.g., within 48 hours).

Legacy MDT is inadequate for a wireless communication system, including NE and/or UE supporting AI/ML. For example, data logging is limited to the RRC idle state, which substantially limits the use of MDT for AI/ML-enabled applications in the wireless communication system. Additionally, the limitation of MDT to a single measurement configuration does not provide the necessary flexibility to measure and report data relevant to AI/ML model training. This is particularly problematic in dynamic conditions, such as during UE mobility or when the UE is in an RRC connected state.

Various aspects of the present disclosure address the above shortcomings by providing flexibility for measurement, logging, and reporting of network performance data by a UE in an RRC idle state and an RRC connected state. Aspects of the present disclosure provide this flexibility by supporting multiple data collection configurations that can be implemented and stored simultaneously at the UE. As such, the UE may be enabled to support multiple measurement, logging, and reporting configurations, which may be linked via different factors (additional conditions) relevant to AI/ML training and inference, which the UE can store and handle (e.g., activate, deactivate, suspend, release) depending on NE-side and/or UE-side conditions.

Additionally, or alternatively, aspects of the present disclosure relate to enabling one or more of the UE or the NE to discard logged data gathered by the UE to reduce memory usage and network impact when reporting measurement data. Additionally, or alternatively, aspects of the present disclosure relate to supporting configurations for an RRC idle state, an RRC connected sate, and an RRC inactive state of a UE. These aspects further provide for continuity when the UE transitions between different RRC states, different measurement and logging configurations for different RRC states, changing RRC states as a trigger condition for various related UE activities, filtering data collected while in the RRC idle state or the RRC inactive state to reduce signaling and improve efficiency, among other features.

Aspects of the present disclosure are described in the context of a wireless communications system.

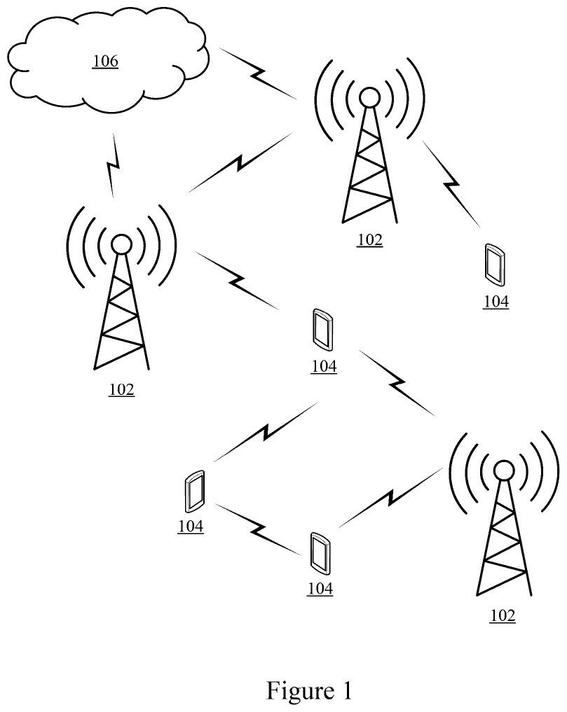

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Embodiments may use features that are also used for MDT. While some aspects of the following description are presented in the context of legacy MDT, they may also be used in novel implementations of the present disclosure.

MDT has two different modes of operation: Immediate MDT and Logged MDT.

Immediate MDT focuses on real-time data collection from a UE configured by the network or triggered by specific events or conditions and is applicable to UEs in RRC_CONNECTED state. Immediate MDT is not applicable to UEs in RRC_IDLE and RRC_INACTIVE states.

In Immediate MDT, a UE performs various network measurements and immediately reports associated measurement data to the network when predefined triggers, such as thresholds for signal strength or quality, are met. The measurement data reported by the UE may include performance indicators such as Reference Signal Received Power (RSRP), Reference Signal Received Quality (RSRQ), and other relevant metrics that provide a snapshot of the network's state.

The immediate reports are used by the network for rapid diagnostics, which enables network operators to swiftly identify and address issues such as coverage gaps, interference problems, or unexpected drops in service quality. As immediate MDT can provide real-time network data, it can be particularly useful in scenarios that demand quick resolution, such as during network outages or when optimizing handovers in dense urban environments.

Logged MDT can enhance network performance monitoring by allowing UEs to collect and log network performance data over time when the UE is in a state without an RRC connection (RRC_IDLE) or without a data connection (RRC_INACTIVE). Unlike Immediate MDT, which reports data in real-time, Logged MDT enables UEs to record various measurements when in RRC_IDLE or RRC_INACTIVE states. The UE can report measurement data later (by switching to RRC_CONNECTED state), typically when the device is idle or connected to a non-cellular network. This approach can provide measurement data without imposing significant overhead on the network or impacting user experience.

The network configures a UE for Logged MDT by specifying the parameters to be measured, the conditions under which measurements are to be taken, and the logging duration. The collected data includes certain network performance metrics such as signal strength (RSRP), signal quality (RSRQ), throughput, and location information, which can be based on global positioning system (GPS) data or a cell-ID. The data is stored in the UE's memory and may be periodically updated as the UE moves through different areas and experiences varied network conditions. Once the logging period is complete or when predefined conditions for data reporting are met, the UE sends the logged data to the network.

Logged and Immediate MDT modes both include data collection and reporting steps. An MDT Configuration message defines criteria for data collection and reporting of the configuration process and contains detailed instructions on what parameters to measure (e.g., signal strength, quality, handover events), when to measure and report (periodically, event-triggered, or based on location), and the format, frequency, and destination for sending the collected data back to the network.

The MeasConfig information element (IE) which is part of an RRCReconfiguration or RRCResume message is used to configure immediate MDT. The MeasConfig IE includes:
1) a measObjectToAddModList and measObjectToRemoveList which contain a list of measurement objects to add or modify and to remove respectively. A measurement object configuration is identified by a measurement object identity. The measurement object, MeasObject, primarily defines what to measure, e.g. a carrier frequency.
2) A reportConfigToAddModList and reportConfigToRemoveList which contain a list of measurement reporting configurations to add or modify and to remove respectively. A measurement reporting configuration is identified by a measurement reporting configuration identity. Each measurement reporting configuration specifies, e.g., the reporting triggering criterion, reference signal (RS) type, reporting format and reporting type. The reporting type can be of event triggered reporting, periodic reporting, cell global identity (CGI) reporting or system frame number (SFN) and frame timing difference (SFTD) reporting.
3) A measIdToAddModList and measIdToRemoveList which contain a list of measurement identities to add or modify and to remove respectively. Each measurement configuration is identified by a measurement identity and links one measurement object configuration with a measurement reporting configuration. By configuring multiple measurement identities, it is possible to link more than one measurement object to the same reporting configuration, as well as to link more than one reporting configuration to the same measurement object.

For Logged MDT, the UE can be configured to start logging using a LoggedMeasurementConfiguration message. Parameters that may be used in MDT (as well as embodiments of the present disclosure) include:
A) Threshold-based logging, in which the network may configure thresholds for different CSI-RS based metrics using which the UE decides when to report/log the data. Such metrics may include reference signal received power (RSRP), reference signal received quality (RSRQ) and signal-to-interference plus noise ratio (SINR).
B) Time-based reporting criteria, including a logging interval, e.g. an interval at which a UE logs the measurement data, typically in ms or seconds (e.g., every 120 ms), and duration, which may be a total duration for which the reporting is active (e.g., over a period of 10 minutes).
C) Location-based reporting criteria, including area-based reporting and spatial relation based reporting (SFTD). For area-based reporting, data collection can be triggered when the UE enters or exits specific cell IDs or an area defined by areaConfiguration. SFTD reporting criteria leverages the concept of “spatial relations” between a UE and reference points, which can be beams (defined by beam reference signals) or cell identities. Reports can be triggered based on events including: entering or leaving a specific beam (SFTD-enter, SFTD-leave); distance to a beam exceeding a certain threshold (SFTD-distance); and distance to a cell exceeding a certain threshold.
D) Event triggered measurements and reporting. The events for this criteria comprise predefined conditions such as changes in signal strength or quality that trigger data collection. The UE starts gathering data when these events occur. A non-exhaustive list of events includes: 1) A serving cell metric becomes better than a threshold; 2) A serving cell metric becomes worse than a threshold; 3) A neighbor cell becomes an amount of offset better than an PCell or PSCell; 4) A neighbor cell becomes better than a threshold; 5) A PCell or PSCell becomes worse than a first absolute threshold AND a neighbor/SCell becomes better than a second threshold; 6) A neighbor becomes an amount of offset better than an SCell; 7) An inter-RAT neighbor cell becomes better than a threshold; and 8) A PCell becomes worse than a first absolute threshold and a neighbor becomes better than another (second) absolute threshold.

For event-based reporting, triggerConfig defines conditions that trigger a measurement report and comprises:

A triggerType field which specifies the type of trigger. Trigger types include an event, such that a report is provided when a specific event such as crossing a signal strength threshold or entering a new cell occurs, a periodic trigger (e.g. reporting at regular intervals), and on demand (e.g. reporting based on an explicit request from the network such as an indication in a message received from a network entity).

An eventId (for event triggers) which identifies a specific event ID.

A triggerQuantity (for event triggers) which indicates a measurement quantity to be monitored for the event (e.g., RSRP, RSRQ, SINR).

Thresholds and offsets, which define threshold values and offsets used for triggering the report.

Hysteresis, which indicates a margin to prevent frequent triggering near a threshold.

A timeToTrigger (for event triggers), which indicates the time duration to wait after the event condition is met before triggering the report.

A reportInterval (for periodic triggers) which indicates the time interval between reports.

A reportAmount (for periodic triggers) which indicates the number of reports to send after a trigger.

A reportOnLeave which indicates whether or not a UE shall initiate the reporting procedure when a leaving condition is met.

In embodiments of the present disclosure, unlike legacy MDT in which reporting is performed immediately in the RRC-connected state without logging data at a UE 104, AI/ML-related measurements may be stored (logged) by a UE 104 in all RRC including the UE_CONNECTED state. The logging of data in all states may have no or minimal effect on network performance since data collected for AI/ML e.g., for training a model, is not latency sensitive. In the following description, the term “logged measurements” may refer to measurement data which is stored in a memory of a UE 104 in any of the RRC_CONNECTED, RRC_IDLE and RRC_INACTIVE states.

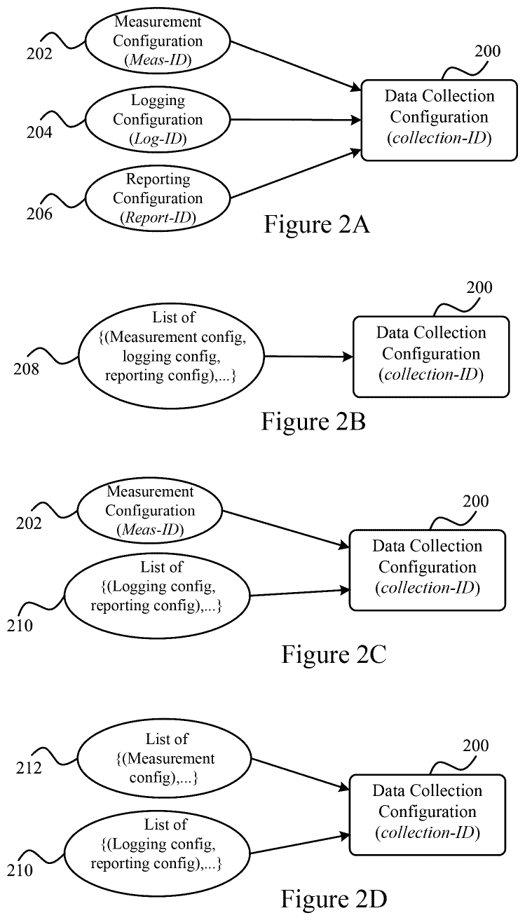

FIGS. 2A, 2B, 2C and 2D illustrate four examples of arrangements of measurement, logging and reporting configurations for a data collection configuration 200 in accordance with aspects of the present disclosure.

A network entity (NE) 102 and UE 104 are likely to encounter a diverse set of conditions which may call for various types and durations of measurements to be performed, and for the associated data to be logged at a UE 104 for different amounts of time and at different time instances. Accordingly, in some embodiments, a UE 104 may store and implement a plurality of data collection configurations at the same time to accommodate different conditions and provide the data used for training different ML models. The measurements taken by a UE 104 are based on a data collection configuration and may be radio frequency measurements such as RSRP, RSRC, SINR, etc.

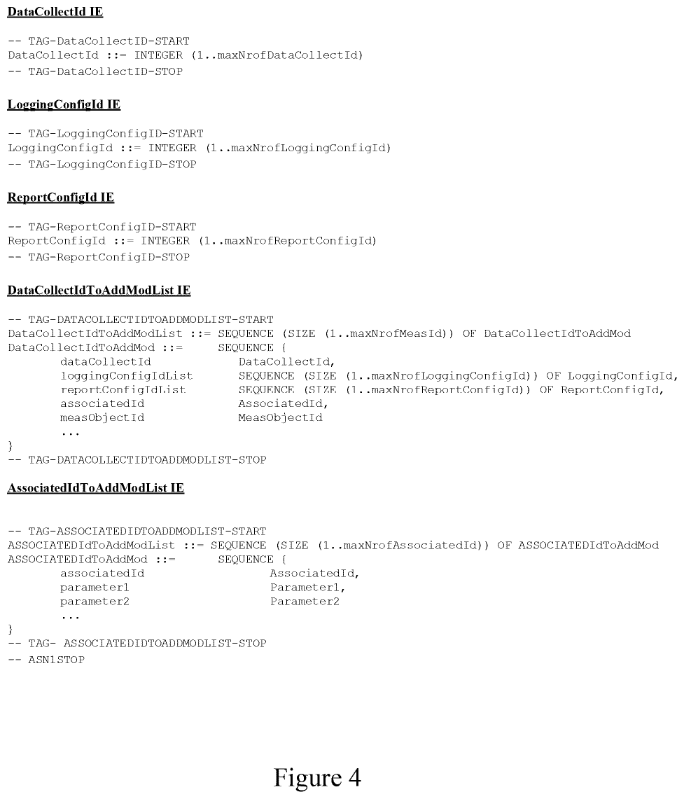

A UE 104 may comprise at least one processor 1002 coupled with at least one memory 1004 and configured to cause the UE 104 to receive a data collection configuration 200 from an NE 102. Each data collection configuration 200 may be associated with and identified by an identifier, e.g. a collection-ID as shown in FIGS. 2A to 2D. The collection-ID may be associated with a dataCollectId information element, an example of which can be seen in FIG. 4. Each collection-ID stored at a UE 104 may be identified by a different integer value for a measurement object, e.g. a frequency/time location and sub-carrier spacing of reference signals to be measured.

Data collection configurations 200 may be received by a UE 104 using dedicated RRC signaling in messages such as RRCReconfiguration or RRCResume. In one example implementation, a network entity 102 may provide one data collection configuration for each network-side condition or UE-side condition. In another example implementation, the network may provide a common data collection configuration for one or more network-side/UE-side conditions. One or more data collection configuration 200 may be linked to a measurement object.

In the example of FIG. 2A, a data collection configuration 200 which is designated by a collection-ID comprises a measurement configuration 202, a logging configuration 204 and a reporting configuration 206. The measurement configuration 202 is associated with a single Meas-ID identifier, the logging configuration 204 is associated with a single Log-ID identifier, and the reporting configuration 206 is associated with a single Report-ID identifier. The data collection configuration 200 in FIG. 2A may be implemented by a UE 104 by measuring data in accordance with measurement configuration 202, logging data associated with the measurements in accordance with logging configuration 204, and reporting data associated with the logged data to a network entity 102 in accordance with reporting configuration 206.

A measurement configuration 202 may comprise parameters for measurements performed by a UE. These parameters may include, for example, the type of measurement (measurement quantity), e.g. RSRP, RSRQ and SINR, measurement objects, time and frequency resources, periodicity, etc. A logging configuration 204 may comprise information for logging measurement data, e.g. information on the format of logged data, logging duration, triggers/indications to start and stop logging of certain measurements, the amount of information to log (e.g. all or only a portion of the measurements), triggers for releasing logged data, thresholds for data that is logged, type of measurement data to log (e.g. samples, associated statistics), etc. A reporting configuration 206 may comprise information for how and when to report data to a network entity 102, for example trigger conditions for when and how to report data, the format of data to report, which data to report, whether reporting is periodic, trigger-based or based on UE or network conditions, etc. Some possible specific contents of a measurement configuration 202, logging configuration 204 and reporting configuration 206 are disclosed above with respect to the LoggedMeasurementConfiguration message.

In the example of FIG. 2B, the data collection configuration 200 comprises a list 208 of measurement, logging and reporting configurations. In an embodiment, each measurement, logging and reporting configuration is associated with a unique identifier such that it can be combined with other configurations of a different type by the UE 104. A UE 104 may implement one measurement configuration, one logging configuration, and one reporting configuration from the list 208 for a given set of measurements. A data collection configuration may comprise instructions comprising indications referring to respective identifiers for how and when to combine different measurement, logging and reporting configurations.

In the example of FIG. 2C, a data collection configuration 200 comprises a single measurement configuration 202 and a list of logging and reporting configurations 210. A UE 104 may perform measurements in accordance with the measurement configuration 202 and some combination of one of the logging configurations and reporting configurations from the list 210. A single measurement configuration 202 may link to a respective pair of logging and reporting configurations for a given set of measurements. The UE 104 may update an existing data collection configuration 200 with a new or changed logging and/or reporting configuration based on a message from a network entity 102 indicating a respective Meas-ID, or alternatively, the message may indicate both the Meas-ID and the collection-ID.

In the example of FIG. 2D, a data collection configuration 200 comprises a list 212 of measurement configurations and a list 201 of logging and reporting configurations. The data collection configuration 200 may also comprise a mapping or linking between the configurations on the lists. The mapping may link a single measurement configuration from the list 212 to a single logging and reporting configuration from the list 210. In another embodiment, multiple configurations may be linked together, e.g. a single logging configuration may be linked with multiple measurement and reporting configurations, a single reporting configuration may be linked with multiple measurement and logging configurations, etc.

The multiple configurations may be associated with different trigger conditions by the data collection configuration 200 so that only one measurement, logging and reporting configuration is used for a set of measurements. The mapping between measurement, reporting and logging configurations may be indicated by the data collection configuration 200, and may be transmitted to a UE 104 by an information element.

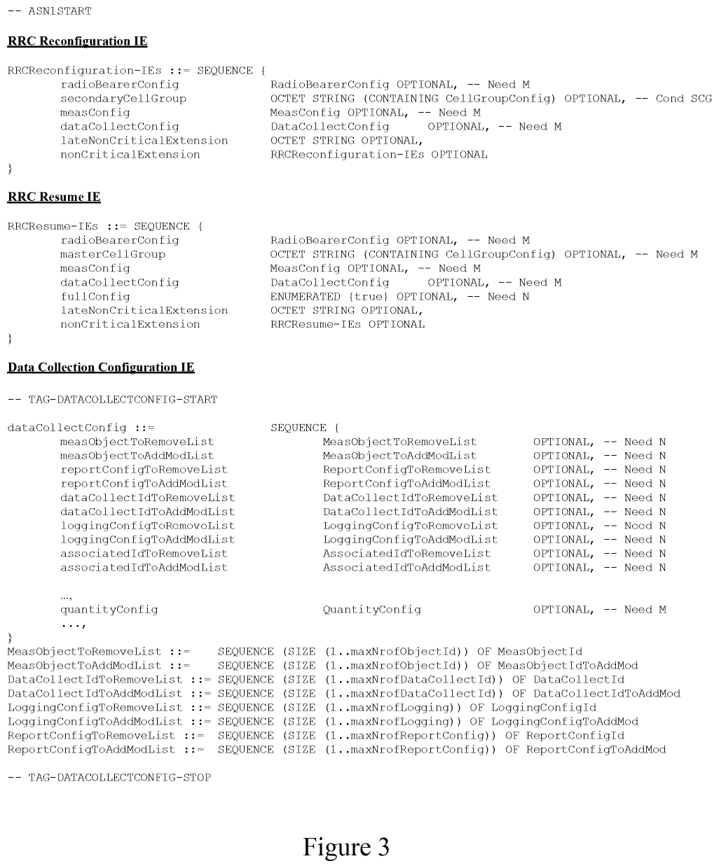

FIG. 3 illustrates an example of RRC Reconfiguration, RRC Resume and Data Collection Configuration information elements, and FIG. 4 illustrates an example of several additional information elements that may be used in some embodiments in accordance with aspects of the present disclosure.

One of the components of the Data Collection Configuration IE in FIG. 3 is a data collection identity, which is presented separately as a DataCollectId IE in FIG. 4. In an embodiment, a data collection identity may link one or more logging configuration and one or more reporting configuration to a measurement object. In another embodiment, the DataCollectId may link a list of logging configurations to one or more reporting configurations, associated ID(s) and the respective measurement object. Each data collection identity may use an integer value as an identifier.

In an example implementation, the associatedId can be linked to the dataCollectId, and using this the UE 104 may automatically switch to another data collection configuration if the UE 104 experiences changes in NW-side or UE-side conditions represented by the associated ID(s). In another embodiment, the network may command the UE 104 to activate or deactivate the configuration and change the current configuration to a different stored configuration by indicating the associatedId in a message transmitted to the UE 104 from an NE 102.

An embodiment may use a new UE variable such as VarMeasConfig which includes the accumulated configuration of the (AI/ML-related) measurements to be performed by the UE 104 covering intra-frequency, inter-frequency and inter-RAT mobility related measurements. Additionally, a variable specific to an individual accumulated configuration for measurement, logging and reporting may be implemented, which may include the respective associated ID. Additional UE variables for measurement reporting and measurement logging may be provided in embodiments as well. The accumulated configurations may comprise a combination of configurations, not limited to only active configurations.

A UE 104 may be adapted to activate and deactivate various measurement configurations. A UE 104 may comprise one or more measurement configuration at a time. In one example implementation, the network may instruct the UE 104 to activate a particular configuration upon receiving the configuration. One or more measurement configuration can be active at the same time.

In some implementations, the network may provide instructions in the configurations to guide the UE to activate, suspend or deactivate certain configurations. A data collection configuration may include conditions or thresholds for activating or deactivating specific measurement configurations. These conditions may depend on the network-side conditions or UE-side conditions. Examples of UE-side conditions include thresholds related to UE battery life, memory, or other hardware limitations. Examples of network-side conditions include gNB settings such as antenna pattern, observed channel conditions, RF module type, TxRU mapping, beam shape/codebook, down tilt angles, direction of the site, deployment scenario, gNB height, etc.

Taking the legacy reporting framework (e.g. reportConfig) as the baseline, a conditional trigger configuration (condTriggerConfig) can be extended for conditional activation/deactivation from one data collection configuration to another by defining conditional reconfiguration event trigger criteria. The logging configurations and reporting configurations can be activated or deactivated individually using the eventTriggerConfig type of configuration, when the measurement quantity remains the same.

In some embodiments, reporting of the logged measurement data may be based on some reporting criteria such as priority-based reporting. As the data to be reported for AI/ML LCM purposes can be large, thus the measurement data should be filtered for purposes of logging and/or reporting. Filtering the data logs to be reported can be beneficial for example for reducing impact on a UE's memory. Measurement data that is logged by a UE 104 and reported to a NE 102 may include measurement samples, as well as associated data such as associated statistics.

In an embodiment, the reporting order may be determined based on the priority level of the data log or the logging configuration. Different modes for reporting may be used by a UE 104 (and included in a reporting configuration) such as UE-triggered reporting, UE-autonomous reporting, network triggered reporting, UE-triggered network decision reporting, UE-initiated network-assisted etc.

A UE 104 may release data collection configurations and associated logged data based on various conditions. When a configuration or data is released, that configuration or data is no longer stored in a UE's memory. Although the following description uses the terms “release” and “discard” to refer to different timers, releasing data and discarding data both refer to removal, or no longer storing associated data in memory.

In one implementation, a data collection configuration stored at a UE 104 may be released when a new data collection configuration with the same configuration ID such as DC_{x,} is received. In another implementation, a stored data collection configuration may be released based on a release timer (release_timer) provided as a configuration parameter of a data collection configuration. Part of the data collection configuration such as one of the logging configurations may be released based on the release timer if the timer is associated to each logging configuration, such as a parameter of a logging configuration.

Different configurations may be stored and may not be released upon completion of the logging duration, such that the stored configurations can be activated again (e.g., by an explicit indication or event-triggered) at a later point in time. A configuration may be released when no further measurements are to be performed with the respective configuration, e.g. after a logging duration expires. An NE 102 may subsequently activate a data collection configuration which has already completed associated reporting but has not been released by transmitting an index associated with that data collection configuration without re-specifying the parameters of the configuration itself.

Measurement data may be logged according to the associated configuration for a logging duration included in the configuration. Logged measurement data may be discarded when they are no longer required. For this purpose, a timer (discard_timer) may be used for determining the time at which a UE 104 discards logged measurement data, and may selectively discard one or both of samples and statistics. Accordingly, in some embodiments, various discard timers may be provided and associated with different measurement data.

The measurement data may be retained by a UE 104 independent of a data collection configuration. For example, in an embodiment, a UE 104 may retain measurement data until a discard timer expires even after an associated data collection configuration is released.

Some embodiments may implement at least two timers for releasing measurement data including a first timer for releasing only a portion of the logged data. A UE 104 may retain a remaining portion of the logged data (e.g. samples and/or statistics of logged samples) after the first timer expires. The UE 104 may be configured with a second timer, and release the remaining samples or sample statistics when the second timer expires. The various measurement data release timers and respective links to portions of logged data may be included in a logging configuration of a data collection configuration.

As noted above, embodiments may use a release_timer associated with a data collection configuration in addition to a discard_timer associated with logged measurement data. There are several different ways that the relationship between the durations of these timers may be employed by a UE 104.

When the duration of the release_timer is the same as the duration of the discard_timer, logged measurement data is discarded when the associated data collection configuration is released. This embodiment may be employed when the measurements data are logged in reference to only one measurement configuration, and may implement a one-to-one mapping of a logging ID for the stored data to a measurement configuration.

In another example implementation, the duration of the discard_timer may be greater than the duration of the release_timer. In this case, the logged measurement data may not be discarded upon release of the respective configuration, and instead may be stored for a longer duration. A longer duration for discard_timer than the release_timer may be used when one measurement configuration is mapped to more than one logging ID(s), e.g. logged data.

In another implementation, the duration of the discard_timer may be smaller than the duration of the release_timer. In this case, logged measurement data may be discarded before the configuration is released. For example, a UE 104 may report the logged measurements for a certain configuration and discard these samples when the discard_timer expires while the configuration may have been deactivated. The stored configuration can be activated again by the UE 104, e.g. in an event-triggered manner or by an explicit instruction received by an NE 102 (on-demand).

In some embodiments, logged measurement data may be discarded, even for an active configuration, based on a trigger condition. The following are a few example triggers which may cause a UE to discard the logged measurement data: Outdated data samples (e.g. the samples are too old to be useful); A discard criteria is fulfilled (such as a certain sample quality threshold); After completing the reporting of measurement data associated with a logging configuration ID; Upon receiving a reconfiguration of the same logged measurement configuration ID; and Upon release of a logged measurement configuration.

A UE 104 may be configured to handle data collection during a handover process. A UE 104 may be configured to continue or suspend data collection upon connecting to a new gNB. For these purposes, the UE may use UE-side or network-side (additional) conditions to evaluate whether to continue or suspend data collection. In the following discussion, the UE-side or network-side conditions may be referred to more generally as additional conditions.

Examples of UE-side and network-side conditions are provided above. These additional conditions may include parameters that may be used to determine the applicability of a functionality and thus selection of an applicable AI/ML model. For example, different vendors may employ different radio technologies such as beam forming techniques that could impact the relevance of measurement data collected by a UE 104, so vendor identity may be a network-side (additional) condition.

For an AI/ML-enabled feature/feature group (FG), additional conditions may refer to any aspects that are assumed for the training of the model but are not a part of UE capability for the AI/ML-enabled feature/FG. This does not imply that additional conditions are necessarily specified. Identifiers referring to additional conditions, e.g., UE-side conditions or NW-side conditions may be represented by associated ID(s) or other similar identifiers.

For an AI/ML-enabled feature/FG, additional conditions may further refer to any aspects that are assumed for the training of the model but may not be a part of UE capability for the AI/ML-enabled feature/FG. Conditions that may vary for different scenarios, sites, settings, or datasets are defined as additional conditions. As noted above, there may be UE-side conditions and NW-side conditions. Associated ID(s) may be Identifiers referring to additional conditions, e.g., UE-side additional conditions or NW-side additional conditions may be represented by associated ID(s). A scenario may be a deployment scenario categorized based on different factors such as channel models (heavy LOS/NLOS conditions, UMi, UMa, InH), outdoor/indoor UE distributions, carrier frequencies, UE speeds, antenna spacings etc. For example, network defined scenarios can be scenarios with network defined dataset categorization. UE defined scenarios can be scenarios with UE defined dataset categorization.

Examples of scenarios include: Various deployment scenarios, e.g., UMa, UMi and others; e.g., 200 m ISD or 500 m ISD and others; e.g., same deployment, different cells with different configuration/assumption; e.g., gNB height and UE height; Various outdoor/indoor UE distributions, e.g., 100%/0%, 20%/80%, and others; and Various UE mobility, e.g., 3 km/h, 30 km/h, 60 km/h and others. Examples of settings include: Various UE parameters, e.g., number of UE Rx beams (including number of panels and UE antenna array dimensions), UE codebook; Various gNB settings, e.g., DL Tx beam codebook (including various Set A of beam(pairs) and gNB antenna array dimensions); and Various Set A of beam and various Set B of beam.

Network-side conditions may be handled using a validity area. A validity area may refer to an area, e.g. a cell, set of cells, or cell characteristics in which certain additional conditions are consistent and valid. Accordingly, a validity area may be linked to additional conditions, and in particular to network-side/UE-side conditions.

In one implementation, the content of additional conditions may be inconsistent among different cells, which implies that a node vendor can use random identifier(s) to indicate the associated ID(s) for the respective additional conditions. In this case, the consistency of the additional condition can be cell-specific, such that a validity area is cell-specific. An indicator for the validity area which may comprise a cell ID or list of cells in this case such as physical cell identity (PCI), or alternatively the L3 cell identity (36 bits), may be linked to the additional conditions. The advantage of such an approach is to maintain data privacy as the association of the ID(s) to the parameters will not be revealed to other sites, nodes, or vendors.

In an alternate implementation, the content of additional conditions is consistent at the vendor level such that the association of the ID(s) to the parameters of additional conditions is the same within all the cells belonging to one vendor. An indicator of vendor information, e.g., proxy ID, may be linked to the additional conditions. In this case, the validity area may be cells from the same vendor.

In another implementation, the content of additional conditions is consistent within a particular area. The association of the ID(s) to the parameters of additional conditions may be the same within that area, e.g., the same to all the cells located in an area such as RAN notification area (RNA). Thus, the validity area may be the RNA area. An indicator such as RNA ID may be linked to the additional conditions.

In yet another implementation, the content of additional conditions is fully visible and fully consistent through different vendors/cells. In this case, all the parameters constituting additional conditions may be specified. Alternatively, the content of additional conditions may be partially visible so that some privacy-sensitive information/parameters remain confidential while the rest of the content is specified. The validity area for this case may not be limited to certain cells. A restriction on the validity area may imposed depending on the implementation. In one possible implementation, a cluster of cells may be used to define the validity area for additional conditions.

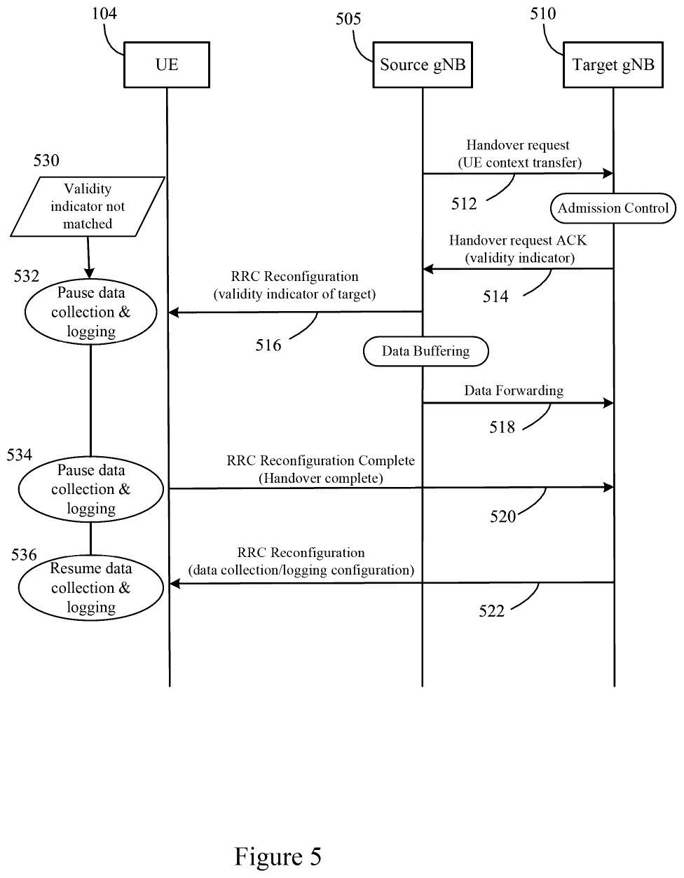

Information may be exchanged between a source gNB 505 and a target gNB 510 to determine the eligibility of a data collection configuration and a logging configuration. FIG. 5 illustrates an example of determining validity in a handover scenario in accordance with aspects of the present disclosure.

During the handover process, after receiving a handover request 512 from a source gNB 505, a target gNB 510 may transmit a validity indicator of its additional conditions to the source gNB 505 in a handover request ACK message. The source gNB 505 may forward the validity indicator received from the target gNB 510 to the UE 104.

In one implementation, the source gNB 505 may send the validity indicator of additional conditions of the target gNB 510 in an RRC reconfiguration message at 516. It can be beneficial for the UE 104 to compare the previous validity indicator of its source gNB 505 to the target at an early stage of the handover process. Alternatively, a new indicator representing the validity of a data collection configuration can be exchanged among the source gNB 505 and the target gNB 510.

The validity indicator may be used by the UE 104 to determine whether to continue collecting data according to one or more current data collection configuration.

When the validity indicator matches the validity area of the source gNB 505, the UE 104 may continue to log measurement data and keep a stored list of data collection and logging configurations. Whether the UE 104 discards the logged data may depend on the configuration. In an embodiment, the source gNB 505 may reconfigure the UE 104 to discard all previously stored measurement results. Alternatively, the UE 104 may be configured with when and how to discard the logged measurement data. The target gNB 510 may reconfigure the UE 104 and update the existing conditional logging, triggers for logging, and reporting.

When the validity area does not match the previous validity area as determined by the UE 104 at 530, in one example implementation, the UE 104 may suspend (pause) the data collection and logging process at 532 and release the stored list of data collection and logging configurations. The logging may either be paused after detecting a different validity area or it may be paused (534) after completing the handover upon receiving a handover complete message, e.g. RRC Reconfiguration Complete message 520. Measurement and logging at the UE 104 may resume at 536 upon receiving an explicit indication from the target gNB 510 after completing the handover or upon receiving a new configuration for data collection. When the validity area does not match the validity area, the UE 104 may perform at least one of releasing the data collection configuration and switching to a different data collection configuration when the validity indicator does not match the validity area.

In some embodiments, the logged measurement data may not be discarded, since the UE 104 may utilize this data for further training, filtering or abstraction of the measurements. Thus, when and how to discard the logged measurement data may be determined by the UE 104 based on a particular implementation, e.g. based on a pre-configuration of the UE 104 or a data collection configuration. Alternatively, the UE 104 may discard the logged data as indicated or triggered by a RRC reconfiguration message 522 from the source gNB 505 or an explicit indication from the target gNB 510.

In another implementation, the UE 104 may keep the list of previous data collection and logging configurations, if so configured. In another example implementation, the UE 104 may be configured to start logging measurement data if the validity area does not match the previous validity area. This may enable the UE 104 to collect samples when the UE 104 is moving from one validity area to another validity area.

In one other example, each data collection configuration may be associated with a certain validity area, so that the data collection configuration remains consistent among all cells/gNBs within the same validity area ID. When the data collection configuration is not released, all the gNBs within the same validity area may be able to restart or activate that data collection configuration using an index associated with the configuration.

Thus, the UE 104 may perform data measurement, measurement logging, measurement data retention and retention of a data collection configuration in a variety of different ways. The UE 104 may pause data collection and logging in a handover process, and either resume immediately after handover, retain the data for future use, or discard the data in various embodiments. Similarly, the data collection configuration may be maintained, released or retained for later use by the UE 104.

Embodiments of the present disclosure further relate to configuring a UE 104 with different parameters (e.g. measurement, logging and reporting parameters) for RRC_IDLE, RRC_INACTIVE, and RRC_CONNECTED states and for transitioning between these states.

In an embodiment, a UE 104 may perform measurements and log associated measurement data in the Connected, Idle and Inactive states, e.g., for the purpose of training or monitoring AI/ML models. As discussed above, multiple data collection configurations can be provided by the network to a UE 104 and the UE 104 may implement two or more data collection configurations at the same time. Each of the data collection configurations may differ, for example, based on the UE-side or network-side conditions or other related factors.

In some embodiments, the network may configure the UE 104 in the RRC_CONNECTED state with data collection configurations for the RRC_IDLE and/or RRC_INACTIVE state. Each of the data collection configurations may be associated with an identifier and additional information representing the validity area of that identifier (e.g. the area in which all gNBs have the same correspondence between the identifier and the data collection configurations).

In one embodiment, a data collection configuration provided for the Connected mode is reused for Idle and Inactive modes. The network may include a flag (indicator) in each configuration indicating whether the corresponding configuration is applicable in the Idle or Inactive state. Alternatively, the network may indicate only a subset of the configuration is to be applied during one or both of the Idle and Inactive states.

Accordingly, in some embodiments, a NE 102 may transmit flags indicating that a data collection configuration, or some portion of a data collection configuration, is to be used for an RRC_CONNECTED state, an RRC_IDLE state and an RRC_INACTIVE state.

In another embodiment, the network may (pre-)configure a UE 104 in the Connected state with one or more default data collection configurations, which can be activated when the UE 104 transitions from Connected to Idle state, from Inactive to Idle state or from Connected to Inactive state. In the latter case, the UE 104 may be configured by the network to apply the last active configuration used in the Connected state upon transitioning from Connected to Inactive state.

In another embodiment, the network may configure a UE 104 with one or more data collection configurations for Idle and Inactive states during an RRC Release procedure. In one example implementation, a data collection configuration is included in the RRCRelease message.

According to the above options, the data collection configurations may be the same for RRC_INACTIVE and RRC_IDLE states. Alternatively, in some cases, the data collection configurations may differ based on the RRC states.

To accommodate these embodiments, new UE variables such as VarMeasIdleConfig, which includes an accumulated configuration of the (AI/ML-related) measurements to be performed by the UE 104 covering intra-frequency, inter-frequency, and inter-RAT mobility-related measurements, may be added for Idle mode. A variable specific to individual accumulated configuration for measurement, logging, and reporting may be introduced, which may include the respective associated ID. Additional UE variables for measurement reporting and measurement logging can be added for Idle and/or Inactive states.

Various embodiments may provide different options to release data collection and logging configurations stored at a UE 104. In one example implementation, a data collection configuration stored at the UE 104 may be released upon completion of the logging duration. Alternatively, a configuration may be released upon receiving a new data collection configuration for Idle mode or Inactive mode with the same configuration ID such as DCₓ, such as a new configuration in an RRCRelease message (similar to measIdleConfig). That is, the UE 104 may replace a data collection configuration that is specific to one mode when the UE 104 receives a new configuration for the same mode with the same configuration ID.

In another implementation, a stored data collection configuration may be released based on a release timer (release_timer) configured as one of the parameters of the data collection configuration. In an example implementation, the release_timer is started when a corresponding configuration is activated. Different configurations may be stored and may retained (not released) upon completion of a logging duration, so they can be activated (e.g., event-triggered) again at a later point in time. Alternatively, a configuration and/or the associated logged data may be released when no further measurements are to be performed with the respective configuration, e.g. after an associated logging duration timer expires.

Embodiments of the present disclosure relate to mechanisms for logging measurement data and maintaining logs of the measurement data. The one or more logging configurations linked to a data collection configuration enable the generation and maintenance of separate measurements and logs of measurement data with respect to certain factors such as network-side and UE-side conditions.

Unlike the legacy MDT procedure, measurement logs created in RRC_CONNECTED state may be present for one or more configurations at a time even after transitioning from Connected to Idle/Inactive state, which may or may not have been reported to the network or retrieved by the network. Therefore, it is useful to provide different possibilities for logging measurements.

When a data collection configuration applied in one or both of the Idle and Inactive states is the same as at least one data collection configuration in Connected mode, several different embodiments are possible. In one example implementation, a UE 104 may append an existing log of data collected in the Connected state with the same logging ID for the configuration with new measurements logged during Idle or Inactive states.

In another implementation, the UE 104 may maintain a log of the measurements performed in Idle/Inactive state that is separate from a log of measurements taken in the Connected state, even when a measurement log created during the Connected state for the same configuration is present. In yet another implementation, the UE 104 may create a sub-log for the same measurement configuration, such that, measurements logged in the Idle/Inactive state can be retrieved and reported separately from logged Connected state measurements.

When a data collection configuration applied in the Idle or Inactive state is different from any of the configurations in Connected mode (e.g. when the UE 104 receives a new configuration applicable only to idle/inactive state), in one example implementation, the UE 104 may create and maintain a separate log with a different logging ID for measurements performed in the Idle or Inactive state from the logging ID used for measurement data logged in the Connected state. In another implementation, the UE 104 may log the measurements depending on the logging configuration, and the configuration and the logged measurements may be identified only with the logging ID.

Thus, in some cases, an additional identifier (e.g., a logging ID) may be used as an identifier of a measurement log performed in RRC Idle or Inactive state different from the logging ID used in the Connected state, whereas, on the other hand, the logging ID allocated to the measurement data logged in Connected state can be used commonly through different RRC states. In some instances, data logs started or created in idle/inactive states may have different IDs than the ones in Connected mode. Otherwise, the same IDs may be used for all RRC states. Different logging ID(s) may exist, but they may or may not be different when transitioning from one RRC state to another (connected to idle or idle to connected). A measurement log may be also associated with an identifier that is associated with the corresponding data collection configurations.

Measurements may be logged according to the configuration active at the UE 104 and the logging duration contained in the configuration. However, certain logged measurement data may discarded when they are no longer useful. For this purpose, embodiments may use another timer (discard_timer) which can be used for determining the time at which to discard logged measurements so that the logged measurement data can be stored after the associated data collection or logging configuration is released. In one example implementation, the discard_timer for logged data is started when the measurement logging starts. In an alternate implementation, the discard_timer for logged data is started after the logging duration is completed.

In one example implementation, a release_timer for releasing a configuration and a discard_timer for logged data may be configured per data collection configuration, which may be common to all the logging configurations linked to a data collection configuration. Alternatively, the release_timer and discard_timer can be configured per logging configuration. In another implementation, one common setting of the release_timer and the discard_timer is configured for all idle mode configurations and/or inactive mode configurations for data collection.

In another example implementation, the UE 104 may discard the logged measurements if the difference between the statistics of the current measurements and the logged measurements are more than a threshold, and this threshold may be set by the network. In yet another example implementation, instead of completely discarding the logged measurements, the UE 104 may be configured to retain information about the samples (e.g., some statistics, a model) after a certain event (e.g., a timer expires, or if the statistics of the current measurements changes significantly compared to the previous measurements).

When a UE 104 logs data according to one or more data collection configuration while in the Idle or Inactive state, the UE 104 may transmit associated data to an NE 102 after transitioning to the Connected state. In an embodiment, the UE 104 may simply report all logged data to the NE 102 after such a transition. However, in embodiments of the present disclosure, the UE 104 may be configured with multiple data collection configurations. In addition, embodiments may support AI/ML purposes such as LCM.

Therefore, the amount of data logged by the UE 104 may be quite large. Accordingly, the present disclosure presents several different embodiments for managing data reporting of logged measurement data.

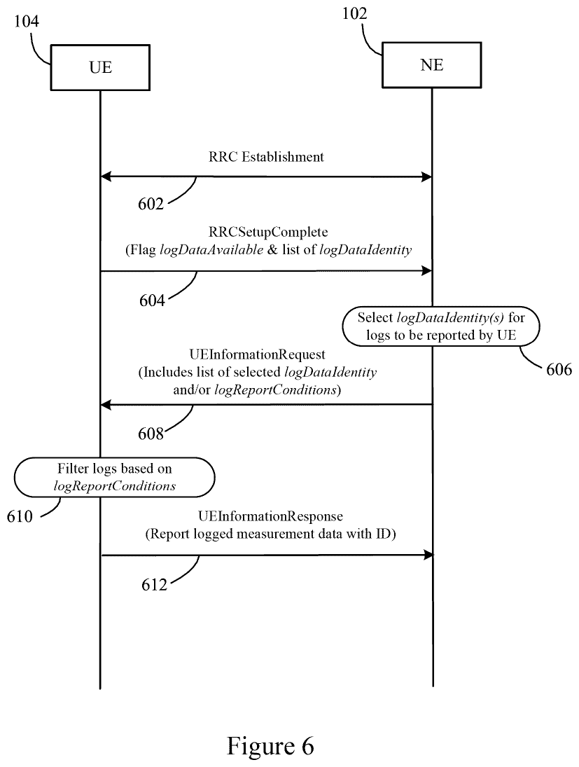

FIG. 6 illustrates an example of signaling for reporting during RRC connection establishment in accordance with aspects of the present disclosure. The example in FIG. 6 uses existing signaling (e.g. RRCSetupComplete). Alternatively, a new RRC message may be implemented for retrieval and reporting of logged measurements for data collection.

RRC establishment takes place between a UE 104 and NE 102 at 602 when the UE 104 transitions from an Idle or Inactive to Connected state. When the RRC connection is established, the UE transmits an RRCSetupComplete message to the NE 102 at 604. The flag logDataAvailable indicating the availability of logged measurement data to be reported may be included in the RRCSetupComplete message for a transition from idle to connected states, or an RRCResumeComplete message for a transition from inactive to connected states.

The size of logged data may be large; therefore, it is beneficial to enable the network to selectively request logged data associated with configurations or conditions. Hence, in an embodiment, along with the flag logDataAvailable in the RRCSetupComplete message at 604 (or RRCResumeComplete), a logDataCollectionReq field provided in an UEInformationRequest message at 608 may include a list of logDataIdentity.

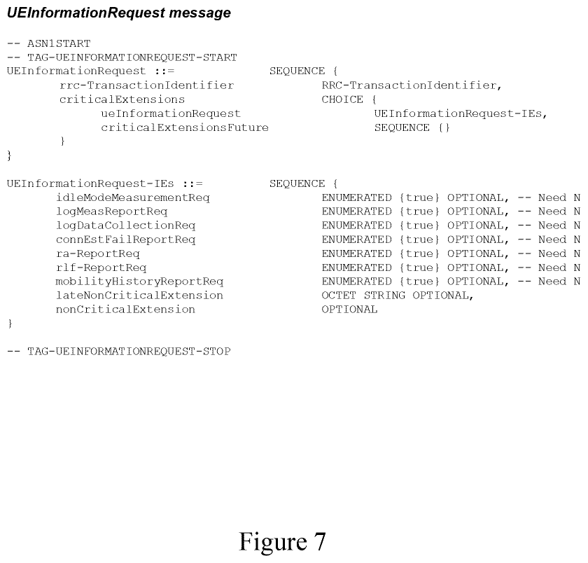

FIG. 7 illustrates an example of a UEInformationRequest message information element which comprises a logDataCollectionReq field in accordance with aspects of the present disclosure.

In response to the UEInformationRequest message at 608, the UE 104 may send the available logged data for the requested logs (logDataIdentity).

In an embodiment, the list of logDataIdentity in the UEInformationRequest may include additional criteria (logReportConditions) for the UE 104 to report the data. Examples of these criteria include: a quality threshold of measurement data to be reported (e.g. a threshold for interference levels, consistency, a minimum number of available samples, or some other quality criteria); a threshold for a number of samples of the measurement data to be reported (e.g., reporting only a portion of the samples logged at the UE); the measurement data in order of recency (e.g., reporting the most recent logged data first); and timing information of when the samples to be reported were measured or logged (e.g., reporting only samples that were measured or logged before of after a specific time or within a specific time interval).

The UE 104 may filter the logs based on the logReportConditions at 610. Subsequently, the UE 104 may report the measurement/data logs for which the reporting criteria (if any) is fulfilled along with the identifier of the logDataIdentity, via an UEInformationResponse message (or a different RRC message) at 612.

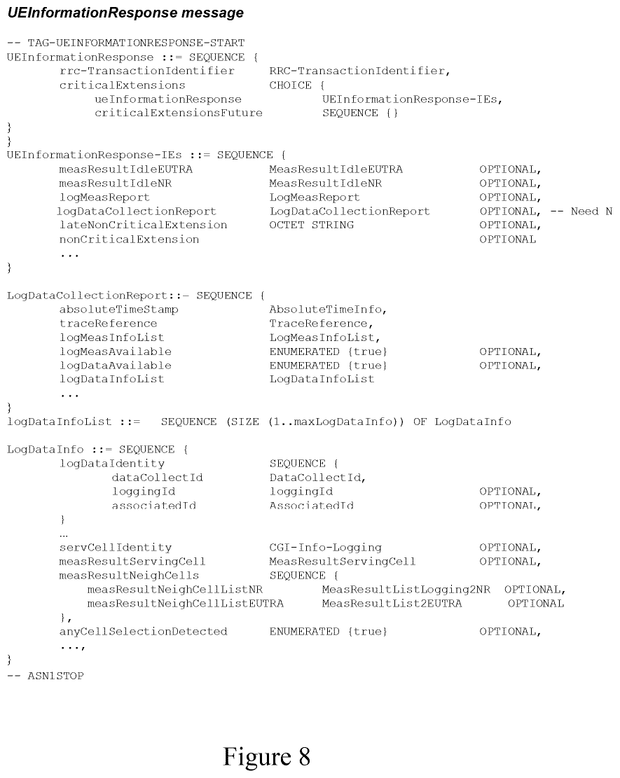

FIG. 8 illustrates an example of a UEInformationResponse message information element in accordance with aspects of the present disclosure. As seen in FIG. 8, the UEInformationResponse IE may be modified in some embodiments to enable segmentation since a large amount of data may be reported for AI/ML LCM.

In an alternate implementation, a new RRC message can be introduced for the network to request the reporting of logged measurements. Similarly, new RRC signaling for reporting the logged measurements may be applied. Although FIG. 6 is illustrated in the context of RRC establishment, the same or similar features may also be applied to RRC Resume and RRC reestablishment procedure.

In an alternate implementation, the availability of the logged data can be requested the network in an UEInformationRequest message at 608, and the UE 104 may respond by providing a logDataAvailable flag and the list of logDataIdentity. If the UEInformationRequest message includes a request from the network inquiring about logged data collection (logDataCollectionReq) to the UE 104, then the UE 104 may respond with information about the logged data in the UEInformationResponse message at 612. The data collection report (logDataCollectionReport) from the UE 104 may include the flag for availability of data as well as additional logged data information.

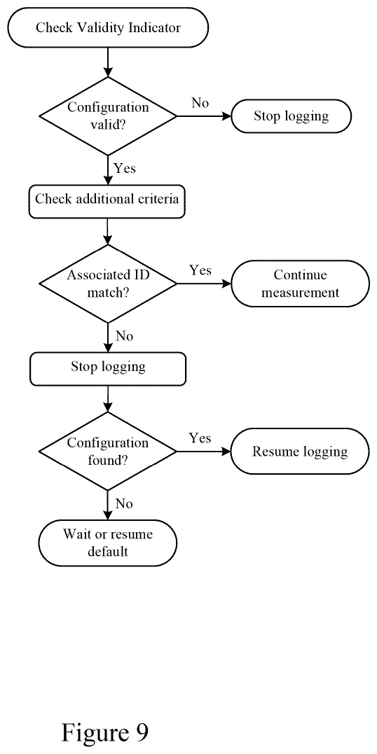

A new process may be used to allow the establishment of an RRC connection for reporting logged data. Legacy MDT does not support this feature. In such an embodiment, a new cause value loggedData may be included in ResumeCause and EstablishmentCause. FIG. 9 illustrates an example of a new process for establishment of an RRC connection for reporting logged data in accordance with aspects of the present disclosure.

After the cell selection/reselection process, when a UE 104 is connected to a new cell, it may perform the following steps as illustrated in FIG. 9. First, the UE 104 may check the validity indicator of the last active data collection configuration. If the new cell does not match the validity indicator, logging may be stopped.

If the new cell matches the validity indicator, then UE checks additional criteria. If one or more network-side conditions indicator (the associated ID in FIG. 9) matches the conditions of the cell, the UE 104 may continue measurements and logs the data with the active data collection configuration unless reconfigured by the network.

If one or more network-side conditions indicator does not match the conditions of the cell, the UE 104 stops or suspends logging with the current active configuration and attempts to find another configuration that matches the conditions (e.g., associated ID(s)) of the new cell. For example, the UE 104 may be configured with a matching configuration.

If a suitable configuration for the cell is found, the UE starts logging with the new data collection configuration. If no suitable configuration is found, the UE 104 may wait for a reconfiguration from the network or resumes to a default data collection configuration if present.

In one example implementation, a validity indicator and/or a network-side conditions indicator (associated ID(s)) may be broadcasted using a System Information message and system information block (SIB). Alternatively, the validity indicator and/or the network-side conditions indicator (associated ID(s)) may be signaled using dedicated RRC signaling if the UE 104 has established the RRC connection.

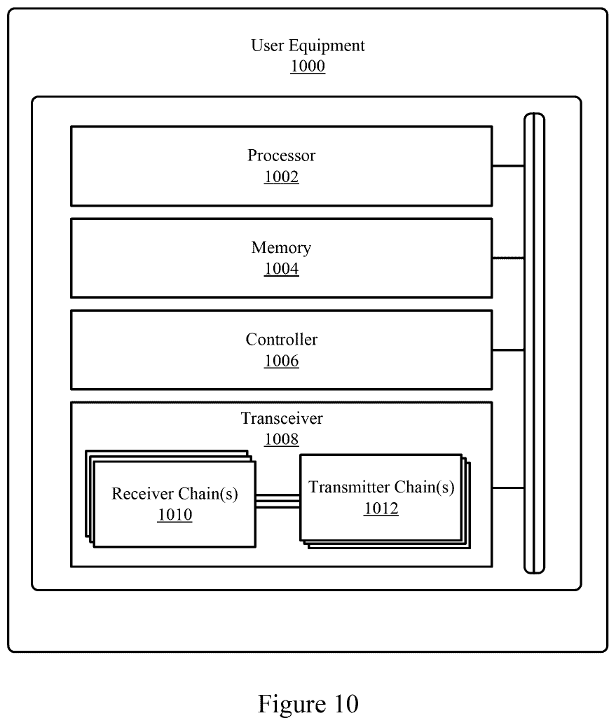

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to support a means for receiving a first message comprising a data collection configuration from a network entity, the data collection configuration comprising at least one measurement configuration, at least one logging configuration, and at least one reporting configuration, performing measurements according to a measurement configuration of the at least one measurement configuration, logging measurement data associated with the measurements according to a logging configuration of the at least one logging configuration by storing the measurement data in at least one memory of the UE, and transmitting a second message to the network entity based on a reporting configuration of the at least one reporting configuration, the second message comprising the logged measurement data.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

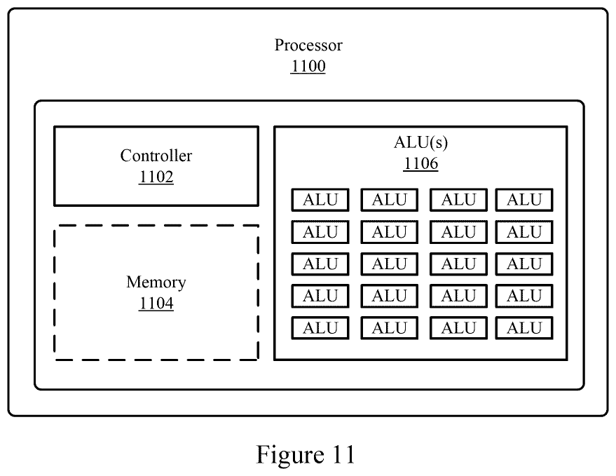

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support a means for receiving a first message comprising a data collection configuration from a network entity, the data collection configuration comprising at least one measurement configuration, at least one logging configuration, and at least one reporting configuration, performing measurements according to a measurement configuration of the at least one measurement configuration, logging measurement data associated with the measurements according to a logging configuration of the at least one logging configuration by storing the measurement data in at least one memory of the UE, and transmitting a second message to the network entity based on a reporting configuration of the at least one reporting configuration, the second message comprising the logged measurement data.

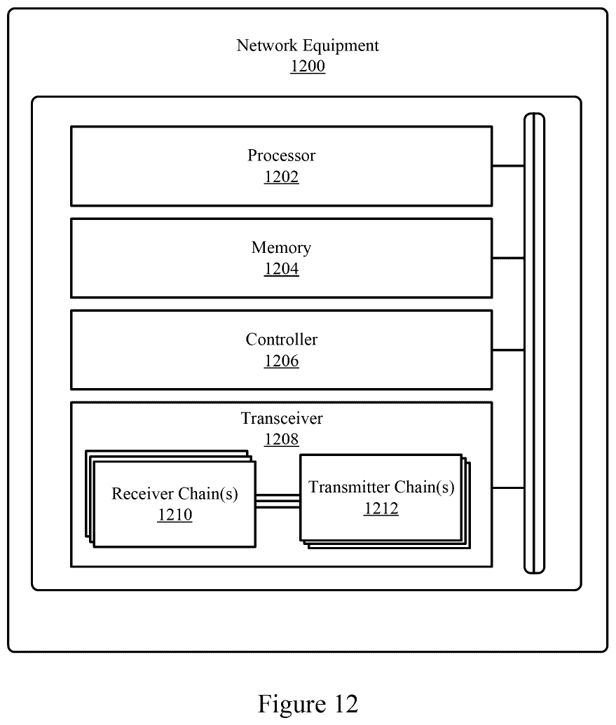

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or a wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

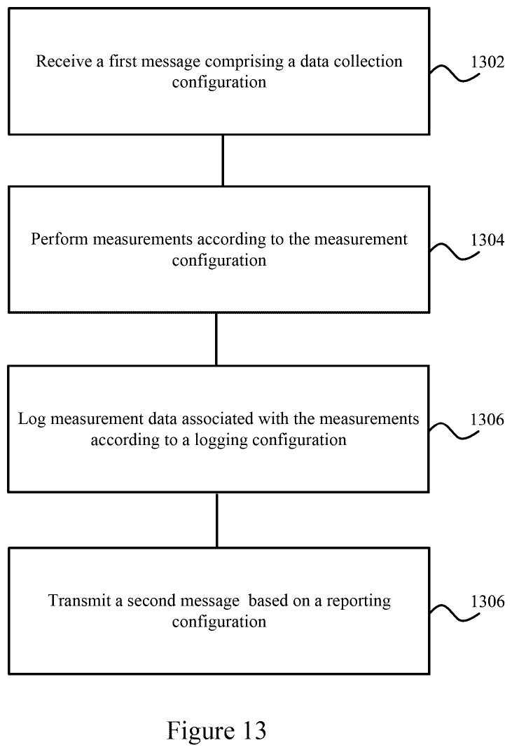

FIG. 13 illustrates a flowchart of a method in accordance with aspects of the present disclosure. The operations of the method may be implemented by a UE as described herein. In some implementations, the UE may execute a set of instructions to control the function elements of the UE to perform the described functions.

At 1302, the method may include receiving a first message comprising a data collection configuration from a network entity. The data collection configuration may comprise at least one measurement configuration, at least one logging configuration, and at least one reporting configuration. The operations of 1302 may be performed in accordance with examples as described herein. In some implementations, aspects of the operations of 1302 may be performed by a UE as described with reference to FIG. 10.

At 1304, the method may include performing measurements according to a measurement configuration of the at least one measurement configuration. The operations of 1304 may be performed in accordance with examples as described herein. In some implementations, aspects of the operations of 1304 may be performed by a UE as described with reference to FIG. 10.

At 1306, the method may include logging measurement data associated with the measurements according to a logging configuration of the at least one logging configuration by storing the measurement data a memory 1104 of the UE. The operations of 1306 may be performed in accordance with examples as described herein. In some implementations, aspects of the operations of 1306 may be performed a UE as described with reference to FIG. 10.

At 1308, the method may include transmitting a second message to the network entity based on a reporting configuration of the at least one reporting configuration, the second message comprising the logged measurement data. The operations of 1308 may be performed in accordance with examples as described herein. In some implementations, aspects of the operations of 1308 may be performed a UE as described with reference to FIG. 10.

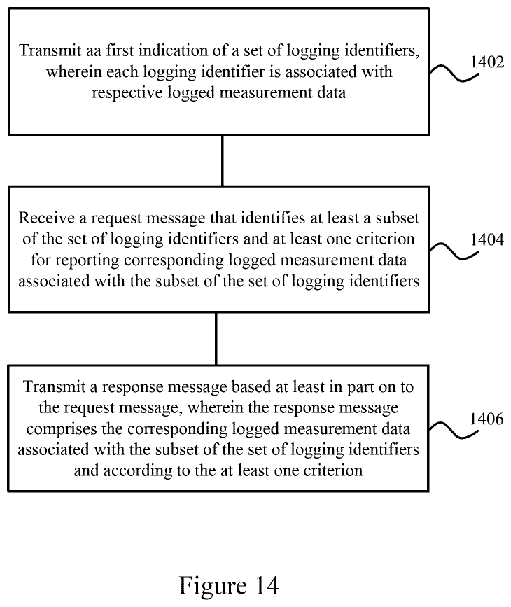

FIG. 14 illustrates a flowchart of another method in accordance with aspects of the present disclosure. The operations of the method may be implemented by a UE as described herein. In some implementations, the UE may execute a set of instructions to control the function elements of the UE to perform the described functions.

At 1402, the method may include transmitting a first indication of a set of logging identifiers, wherein each logging identifier is associated with respective logged measurement data. The operations of 1402 may be performed in accordance with examples as described herein. In some implementations, aspects of the operations of 1402 may be performed by a UE as described with reference to FIG. 10.

At 1404, the method may include receiving a request message that identifies at least a subset of the set of logging identifiers and at least one criterion for reporting corresponding logged measurement data associated with the subset of the set of logging identifiers. The operations of 1404 may be performed in accordance with examples as described herein. In some implementations, aspects of the operations of 1404 may be performed by a UE as described with reference to FIG. 10.

At 1406, the method may include transmit a response message based at least in part on to the request message, wherein the response message comprises the corresponding logged measurement data associated with the subset of the set of logging identifiers and according to the at least one criterion. The measurement data may include data which is associated with the set of logging identifiers and consistent with the reporting criteria from the network entity. The operations of 1406 may be performed in accordance with examples as described herein. In some implementations, aspects of the operations of 1406 may be performed by a UE as described with reference to FIG. 10.

It should be noted that the methods described herein describe possible implementations, and that the operations and the steps may be rearranged or otherwise modified and that other implementations are possible.

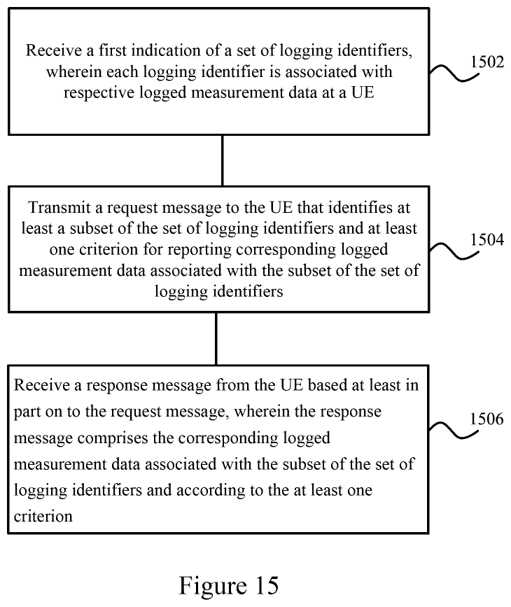

FIG. 15 illustrates a flowchart of a method in accordance with aspects of the present disclosure. The operations of the method may be implemented by a NE as described herein. In some implementations, the NE may execute a set of instructions to control the function elements of the NE to perform the described functions.

At 1502, the method may include receiving a first indication of a set of logging identifiers, wherein each logging identifier is associated with respective logged measurement data at a UE. The operations of 1502 may be performed in accordance with examples as described herein. In some implementations, aspects of the operations of 1502 may be performed by a NE as described with reference to FIG. 12.

At 1504, the method may include transmitting a request message to the UE that identifies at least a subset of the set of logging identifiers and at least one criterion for reporting corresponding logged measurement data associated with the subset of the set of logging identifiers. The operations of 1504 may be performed in accordance with examples as described herein. In some implementations, aspects of the operations of 1504 may be performed by a NE as described with reference to FIG. 12.

At 1506, the method may include receiving a response message from the UE based at least in part on to the request message, wherein the response message comprises the corresponding logged measurement data associated with the subset of the set of logging identifiers and according to the at least one criterion. The operations of 1506 may be performed in accordance with examples as described herein. In some implementations, aspects of the operations of 1506 may be performed a NE as described with reference to FIG. 12.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first message comprising a data collection configuration from a network entity, the data collection configuration comprising at least one measurement configuration, at least one logging configuration, and at least one reporting configuration;
perform measurements according to a measurement configuration of the at least one measurement configuration;
log measurement data associated with the measurements according to a logging configuration of the at least one logging configuration by storing the measurement data in the at least one memory; and
transmit a second message to the network entity based on a reporting configuration of the at least one reporting configuration, the second message comprising the logged measurement data.

2. The UE of claim 1, wherein the first message comprises an indication to activate, deactivate, suspend or release one or more of a measurement configuration, a logging configuration, and a reporting configuration of the data collection configuration.

3. The UE of claim 1, wherein one or more of the at least one measurement configuration, the at least one logging configuration, and the at least one reporting configuration is linked to UE-side or network-side conditions.

4. The UE of claim 1, wherein the at least one processor is further configured to cause the UE to autonomously activate, deactivate, suspend or release the data collection configuration.

5. The UE of claim 1, wherein the at least one processor is further configured to cause the UE to transmit the second message based on at least one of an indication received from the network entity, satisfying a condition preconfigured at the UE, UE-side conditions, and network-side conditions.

6. The UE of claim 1, wherein the data collection configuration comprises an indication for a release timer, and the UE releases the data collection configuration when the release timer expires.

7. The UE of claim 1, wherein the at least one processor is further configured to cause the UE to release the data collection configuration in response to at least one of the following conditions:
expiration of a release timer,
an indication received from the network entity,
a new data collection configuration with an identifier that matches an identifier of the data collection configuration, and
expiration of a logging duration indicated by the data collection configuration.

8. The UE of claim 1, wherein the at least one processor is further configured to cause the UE to release the logged measurement data from the at least one memory based on one or more of:
expiration of a discard timer,
after reporting the logged measurement data,
an indication received from the network entity, and
satisfying a trigger condition at the UE.

9. The UE of claim 1, wherein the at least one processor is further configured to cause the UE to perform the measurements and store the measurements in the at least one memory while in an RRC_CONNECTED state.

10. The UE of claim 1, wherein the at least one processor is further configured to cause the UE to:
receive, in a handover process, a validity indicator from a target base station;
compare the validity indicator to a validity area associated with the data collection configuration; and
determine whether to continue performing the measurements and logging the measurement data based on a result of the comparison, wherein the UE is configured to continue performing the measurements and logging the measurement data when the validity indicator matches the validity area.

11. The UE of claim 10, wherein the at least one processor is further configured to cause the UE to perform at least one of releasing the data collection configuration and switching to a different data collection configuration when the validity indicator does not match the validity area.

12. A processor for wireless communication, comprising:
at least one controller coupled with at least one memory and configured to cause the processor to:
receive a first message comprising a data collection configuration from a network entity, the data collection configuration comprising at least one measurement configuration, at least one logging configuration, and at least one reporting configuration;
perform measurements according to a measurement configuration of the at least one measurement configuration;
log measurement data associated with the measurements according to a logging configuration of the at least one logging configuration by storing the measurement data in the at least one memory; and
transmit a second message to the network entity based on a reporting configuration of the at least one reporting configuration, the second message comprising the logged measurement data.

13. The processor of claim 12, wherein the first message comprises an indication to activate, deactivate, suspend or release one or more of a measurement configuration, a logging configuration, and a reporting configuration of the data collection configuration.

14. The processor of claim 12, wherein one or more of the at least one measurement configuration, the at least one logging configuration, and the at least one reporting configuration is linked to UE-side or network-side conditions.

15. The processor of claim 12, wherein the at least one controller is further configured to cause the processor to autonomously activate, deactivate, suspend or release the data collection configuration.

16. The processor of claim 12, wherein the data collection configuration comprises an indication for a release timer, and instructions to release the data collection configuration when the release timer expires.

17. The processor of claim 12, wherein the at least one controller is further configured to cause the processor to release the data collection configuration in response to at least one of the following conditions:
expiration of a release timer,
an indication received from the network entity,
a new data collection configuration with an identifier that matches an identifier of the data collection configuration, and
expiration of a logging duration indicated by the data collection configuration.

18. The processor of claim 12, wherein the at least one controller is further configured to cause the processor to release the logged measurement data from the at least one memory based on one or more of:
expiration of a discard timer,
after reporting the logged measurement data,
an indication received from the network entity, and
satisfying a trigger condition.

19. The processor of claim 12, wherein the at least one controller is further configured to cause the processor to perform the measurements and store the measurements in the at least one memory while in an RRC_CONNECTED state.

20. A method performed by a user equipment (UE), the method comprising:
receiving a first message comprising a data collection configuration from a network entity, the data collection configuration comprising at least one measurement configuration, at least one logging configuration, and at least one reporting configuration;
performing measurements according to a measurement configuration of the at least one measurement configuration;
logging measurement data associated with the measurements according to a logging configuration of the at least one logging configuration by storing the measurement data in at least one memory of the UE; and
transmitting a second message to the network entity based on a reporting configuration of the at least one reporting configuration, the second message comprising the logged measurement data.
